(19) United States
(12) Patent Application Publication
(10) Pub. No.: US 2024/0059874 A1
(43) Pub. Date: Feb. 22, 2024

(54) RUBBER COMPOSITION COMPRISING A CRUMB RUBBER

(71) Applicant: COMPAGNIE GENERALE DES ETABLISSEMENTS MICHELIN, Clermont-Ferrand (FR)

(72) Inventor: ETIENNE FLEURY, Clermont-Ferrand (FR)

(21) Appl. No.: 18/267,968

(22) PCT Filed: Nov. 29, 2021
(86) PCT No.: PCT/FR2021/052121

§ 371 Date: Jun. 16, 2023

(30) Foreign Application Priority Data
Dec. 22, 2020 (FR) FR2013921

(51) Int. Cl. C08L 7/00; B60C 1/00; C08K 3/04

(52) U.S. Cl. CPC C08L 7/00; B60C 1/0016; C08K 3/04; C08L 2205/025; C08L 2205/035; C08L 2207/24

(57) ABSTRACT

A rubber composition is based on at least 50 to 100 phr of a copolymer containing ethylene units and 1,3-diene units, the ethylene units in the copolymer representing more than 50 mol % of the monomer units of the copolymer, 0.1 to 9% by mass of crumb rubber, a reinforcing filler and a crosslinking system.

The invention relates to rubber compositions comprising crumb rubbers, notably for use in rubber articles, such as tyres.

It is advantageous at the current time for manufacturers to be able to reuse products made from recycled rubber, in rubber articles. Crumb rubbers are particularly advantageous in this context since they result from the recycling by grinding of rubber articles. They are generally used as fillers in mixtures used to produce parts that are not subjected to high mechanical or dynamic stresses.

It would nevertheless be advantageous to be able to use them in more highly technical articles, by better controlling the properties of the compositions containing them.

It is known in the prior art that crumb rubbers can be used in tyres. For example, document WO 2019/243711 A1 describes the use of certain crumb rubbers in tyre compositions.

It is also known, as described, for example, in WO 2020/053521 A1 that copolymer elastomers containing ethylene units and 1,3-diene units may be used in rubber compositions for tyres.

Thus, the Applicant has found that the combined use of a specific amount of crumb rubber and a specific elastomer makes it possible to obtain rubber compositions with excellent endurance properties.

The invention relates to a rubber composition based on at least 50 to 100 phr of a copolymer containing ethylene units and 1,3-diene units, the ethylene units in the copolymer representing more than 50 mol % of the monomer units of the copolymer, 0.1 to 9% by mass of crumb rubber, a reinforcing filler and a crosslinking system.

The invention also relates to a rubber article comprising the composition according to the invention, and preferentially a tyre comprising a composition according to the invention, preferably in all or part of its tread. In this case, the tyre according to the invention will preferably be chosen from tyres intended to equip a two-wheeled vehicle, a passenger vehicle, or else a “heavy-duty” vehicle (that is to say, underground trains, buses, off-road vehicles, heavy road transport vehicles, such as trucks, tractors or trailers), or else aircraft, construction equipment, heavy agricultural vehicles or handling vehicles.

Preferably, the invention relates to a vehicle tyre of the heavy goods type, comprising the composition according to the invention, preferably in all or part of its tread.

### I−CONSTITUENTS OF THE COMPOSITION OF THE INVENTION

The rubber compositions according to the invention are based on at least one copolymer containing ethylene units and 1,3-diene units, a crumb rubber, a reinforcing filler and a crosslinking system.

The expression “composition based on” should be understood as meaning a composition comprising the mixture and/or the product of the in situ reaction of the various base constituents used, some of these constituents being able to react and/or being intended to react with each other, at least partially, during the various phases of manufacture of the composition or during the subsequent curing, modifying the composition as it is prepared at the start.

Moreover, for the purposes of the present patent application, the term “phr” means part by weight per hundred parts of elastomers, for the purposes of the preparation of the composition before curing. That is to say, in the case of the presence of a crumb rubber, that the term “phr” means part by weight per hundred parts of “new” elastomers, thus excluding from the base 100 the elastomers contained in the crumb rubber.

In the present description, unless expressly indicated otherwise, all the percentages (%) shown are mass percentages. Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

When reference is made to a “predominant” compound, this is understood to mean, for the purposes of the present invention, that this compound is predominant among the compounds of the same type in the composition, that is to say that it is the one which represents the greatest amount by mass among the compounds of the same type and in particular more than 50%, preferably more than 75%. Thus, for example, a predominant polymer is the polymer representing the greatest mass relative to the total mass of the polymers in the composition. In the same way, a “predominant” filler is that representing the greatest mass among the fillers of the composition. By way of example, in a system comprising just one polymer, the latter is predominant for the purposes of the present invention and, in a system comprising two polymers, the predominant polymer represents more than half of the mass of the polymers. On the contrary, a “minor” compound is a compound which does not represent the greatest fraction by mass among the compounds of the same type.

For the purposes of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by mass among the units (or monomers) forming the compound (or polymer).

The compounds mentioned in the description may be of fossil origin or may be biobased. In the latter case, they may be partially or totally derived from biomass or may be obtained from renewable starting materials derived from biomass. Similarly, the compounds mentioned may also be derived from the recycling of already-used materials, i.e. they may be partly or totally derived from a recycling process, or obtained from raw materials which are themselves derived from a recycling process. Polymers, plasticizers, fillers, etc. are notably concerned.

### I-1 Elastomer

The elastomer that is useful for the purposes of the invention is a highly saturated diene elastomer, which is preferably a statistical copolymer, which comprises ethylene units resulting from the polymerization of ethylene. In a known manner, the term “ethylene unit” refers to the —(CH₂—CH₂)— unit resulting from the insertion of ethylene into the elastomer chain. The highly saturated diene elastomer is a copolymer rich in ethylene units, since the ethylene units represent at least 50 mol % of all of the monomer units of the elastomer.

Preferably, the highly saturated diene elastomer comprises at least 65 mol % of ethylene units. In other words, the ethylene units preferentially represent at least 65 mol % of all of the monomer units of the highly saturated diene elastomer. More preferentially, the highly saturated diene elastomer comprises from 65 mol % to 90 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the expression “1,3-diene unit” refers to the units resulting from the insertion of 1,3-diene via a 1,4 addition, a 1,2 addition or a 3,4 addition in the case of isoprene. The 1,3-diene units are those, for example, of a 1,3-diene containing 4 to 12 carbon atoms, such as 1,3-butadiene, isoprene, 1,3-pentadiene or an aryl-1,3-butadiene. Preferably, the 1,3-diene is 1,3-butadiene, in which case the highly saturated diene elastomer is a copolymer of ethylene and of 1,3-butadiene, which is preferably statistical.

The highly saturated diene elastomer that is useful for the purposes of the invention may be obtained according to various synthetic methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the Applicant. The highly saturated diene elastomer, including the case when it is random, may also be prepared via a process using a catalytic system of preformed type such as those described in WO 2017/093654 A1, WO 2018/020122 A1 and WO 2018/020123 A1.

For the invention, the highly saturated diene elastomer preferably contains units of formula (I) or units of formula (II).

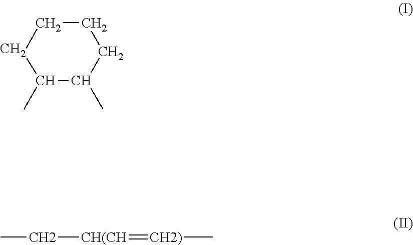

The presence of a saturated 6-membered ring unit, 1,2-cyclohexanediyl, of formula (I) in the copolymer may result from a series of very specific insertions of ethylene and of 1,3-butadiene into the polymer chain during its growth. When the highly saturated diene elastomer comprises units of formula (I) or units of formula (II), the molar percentages of the units of formula (I) and of the units of formula (II) in the highly saturated diene elastomer, o and p respectively, preferably satisfy the following equation (eq. 1), more preferentially the equation (eq. 2), and more preferentially the equation (eq. 3), o and p being calculated on the basis of all of the monomer units of the highly saturated diene elastomer.

0<o+p≤35 (eq. 1)

0<o+p≤25 (eq. 2)

0<o+p<20 (eq. 3)

The highly saturated diene elastomer that is useful for the purposes of the invention may consist of a mixture of highly saturated diene elastomers which differ from each other in their microstructures or in their macrostructures.

According to the invention, the content of the highly saturated diene elastomer in the rubber composition is at least 50 parts by weight per hundred parts of elastomer of the rubber composition (phr). Preferably, the content of the highly saturated diene elastomer in the rubber composition varies in a range extending from 80 to 100 phr. More preferentially, it varies in a range extending from 90 to 100 phr.

As a further option, if another elastomer is present in the composition, it may be chosen from the group consisting of diene elastomers and mixtures thereof. “Diene” elastomer (or, without distinction, rubber), whether natural or synthetic, is given to mean, as is known, an elastomer at least partially composed (i.e. a homopolymer or a copolymer) of diene monomer units (monomers bearing two conjugated or non-conjugated carbon-carbon double bonds). The diene elastomer is preferentially selected from the group consisting of polybutadienes (BRs), polyisoprenes—which are synthetic rubbers (IRs) or natural rubber (NR)—, butadiene copolymers, isoprene copolymers, and mixtures of these elastomers. Such butadiene copolymers and isoprene copolymers are more preferentially, respectively, butadiene/styrene copolymers (SBRs) and isoprene/styrene copolymers (SIRs).

### Determination of the Microstructure of the Elastomers

The microstructure of the elastomers is determined by ¹H NMR analysis, combined with ¹³C NMR analysis when the resolution of the ¹H NMR spectra does not make it possible to assign and quantify all the entities. The measurements are performed using a Brüker 500 MHz NMR spectrometer at frequencies of 500.43 MHz for proton observation and 125.83 MHz for carbon observation. For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz. For the measurements on soluble elastomers, a liquid NMR probe is used for proton and carbon observation in proton-decoupled mode. The preparation of the insoluble samples is performed in rotors filled with the analysed material and a deuterated solvent enabling swelling, generally deuterated chloroform (CDCl₃). The solvent used must always be deuterated and its chemical nature may be adapted by those skilled in the art. The amounts of material used are adjusted so as to obtain spectra of sufficient sensitivity and resolution. The soluble samples are dissolved in a deuterated solvent (about 25 mg of elastomer in 1 ml), generally deuterated chloroform (CDCl₃). The solvent or solvent blend used must always be deuterated and its chemical nature may be adapted by those skilled in the art. In both cases (soluble sample or swollen sample) a 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement. A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement. The NMR measurements are performed at 25° C.

### I-2 Crumb Rubber

The composition of the invention also comprises a crumb rubber (abbreviated to “crumb” in the remainder of the text).

The crumbs are presented in the form of granules, optionally put into the form of a rubber plaque. Generally, crumb rubbers result from a grinding or from a micronization of cured rubber compositions already used for a first application, for example in tyres; they are a product of recycling of the materials. The crumbs thus preferably consist of a composition based on at least one elastomer and a filler. The crumbs are preferably provided in the form of microparticles.

The term “microparticles” is intended to mean particles which have a size, namely their diameter in the case of spherical particles or their largest dimension in the case of anisometric particles, of a few tens of or a few hundred microns.

According to the invention, the crumb rubber is present in an amount in the range from 0.1% to 9% by mass in the composition (i.e. relative to the total mass of the composition), preferentially from 0.5% to 7% by mass and more preferentially from 1 to 6% by mass. In a typical composition intended for tyres, these mass contents preferentially correspond to contents of about 0.1 to 16 phr. Preferably, the crumb content is within a range from 0.5 to 15 phr, preferentially from 1 to 12 phr, more preferentially from 1 to 10 phr and very preferentially from 2 to 10 phr.

The crumb rubber preferentially has a mean size D50 of between 100 and 300 μm.

Also, the crumb preferably has a particle size distribution such that the ratio of the mean sizes D10/D50 is greater than or equal to 0.5, preferably between 0.55 and 0.95 and more preferentially between 0.6 and 0.9, and even more preferentially between 0.65 and 0.85.

These specific crumbs can be obtained by various technologies, in particular by cryogenic micronization processes as described in documents U.S. Pat. Nos. 7,445,170 and 7,861,958. According to another embodiment of the invention, the crumbs can be obtained by other micronization processes known to those skilled in the art and not limited to the cryogenic process alone.

Depending on the size distribution of objects obtained, the crumb obtained by the cited processes can undergo an additional sieving step so as to control this distribution. The sieving can be performed by various technologies (vibration, centrifugation, suction) known to those skilled in the art.

Likewise, commercially available crumbs such as the Polydine PD80 crumb from Lehigh Technologies can be used.

As discussed above, the crumbs preferably consist of a composition based on an elastomer and a filler. They may also comprise all the ingredients normally used in rubber compositions, such as plasticizers, antioxidants, vulcanization additives, etc.

Thus, the crumb comprises an elastomer, preferentially a diene elastomer. This elastomer preferentially represents at least 30% by mass, more preferentially at least 35% by mass, even more preferentially at least 45% by mass relative to the weight of the crumb, said percentage being determined according to the standard ASTM E1131. It is preferentially selected from the group consisting of polybutadienes, polyisoprenes including natural rubber, butadiene copolymers and isoprene copolymers. More preferentially, the molar content of units of diene origin (conjugated dienes) present in the diene elastomer is greater than 50%, preferably between 50% and 70%.

According to a preferred embodiment of the invention, the crumb contains between 5% and 80% by mass of filler, more preferably between 10% and 75% and very preferentially between 15% and 70%.

The term “filler” is understood here to mean any type of filler, whether it is reinforcing (typically having nanometric particles, preferentially with a weight-average size of less than 500 nm, in particular between 20 and 200 nm) or whether it is non-reinforcing or inert (typically having micrometric particles, preferentially with a weight-average size of greater than 1 μm, for example between 2 and 200 μm). The weight-average size of the nanometric particles is measured in a manner well known to those skilled in the art (by way of example, according to application WO 2009/083160 paragraph I.1). The weight-average size of the micrometric particles can be determined by mechanical sieving.

Mention will in particular be made, as examples of fillers known as reinforcing to those skilled in the art, of carbon black or of a reinforcing inorganic filler, such as silica or alumina in the presence of a coupling agent, or mixtures thereof.

According to a preferred embodiment of the invention, the crumb comprises, by way of filler, a reinforcing filler, in particular a carbon black or a mixture of carbon blacks.

The carbon black or the mixture of carbon blacks preferentially represents more than 50%, more preferentially more than 80%, even more preferentially more than 90% by mass relative to the weight of the reinforcing filler of the crumb. According to a more preferred embodiment, the reinforcing filler consists of a carbon black or a mixture of carbon blacks.

Very preferentially, the carbon black is present in the crumb in a content ranging from 20% to 40% by mass, more preferentially from 25% to 35% by mass.

All carbon blacks, in particular blacks of the HAF, ISAF, SAF, FF, FEF, GPF and SRF type, conventionally used in rubber compositions for tyres (“tyre-grade” blacks) are suitable as carbon blacks.

The crumb can contain all the other usual additives which participate in a rubber composition, in particular for a tyre. Among these usual additives, mention may be made of liquid or solid plasticizers, non-reinforcing fillers such as chalk, kaolin, protective agents, vulcanization agents. These additives may also be in the crumb in the form of a residue or of a derivative, since they were able to react during the steps of producing the composition or of crosslinking the composition from which the crumb is derived.

The crumbs can be simple ground/micronized rubber materials, without other treatment. It is also known that these crumbs can undergo a treatment in order to modify them. This treatment can consist of a chemical functionalization or devulcanization modification. It can also be a thermomechanical, thermochemical, biological, etc. treatment. Preferentially for the invention, use is made of a crumb which has not undergone any modification by thermal and/or mechanical and/or biological and/or chemical treatment.

As regards the constituents of the crumb, it is preferable, for the requirements of the invention, for the crumb to have an acetone extract of between 3% and 30% by mass, more preferentially between 3% and 15% by mass, more preferentially between 3% and 10% by mass.

It is also preferable for the crumb to have a chloroform extract of between 3% and 85% by mass, more preferentially between 3% and 20% by mass, more preferentially between 5% and 15% by mass.

Preferably, the chloroform extract of the crumb rubber has a mass-average molecular mass (Mw) of less than 10,000 g/mol, preferably of less than 8000 g/mol.

Preferably, in this type of crumb, the ratio of the chloroform extract to the acetone extract, expressed as mass percentage, is less than 1.5.

The characteristics of the crumb rubbers, as described above, are measured as shown below.

### Measurement of the Size of the Crumb Particles:

The crumb particle size mass distribution may be measured by laser particle size analysis, on a Mastersizer 3000 device from the company Malvern. The measurement is performed by the liquid route, diluted in alcohol after an ultrasound pretreatment for 1 min in order to guarantee the dispersion of the particles. The measurement is performed in accordance with the standard ISO-13320-1 and makes it possible to determine in particular the D10 and the D50, that is to say the mean diameter below which respectively 10% by mass and 50% by mass of the total population of particles are present.

### Measurement of the Mass Fraction of Carbon Black:

The carbon black mass fraction is measured by thermogravimetric analysis (TGA) according to the standard NF T-46-07, on an instrument from the company Mettler Toledo, model “TGA/DSC1”. Approximately 20 g of sample are introduced into the thermal analyser, then subjected to a thermal program from 25 to 600° C. under an inert atmosphere (pyrolysable phase), then from 400 to 750° C. under an oxidizing atmosphere (oxidizable phase). The mass of the sample is measured continuously throughout the thermal program. The organic matter content corresponds to the loss of mass measured during the pyrolysable phase relative to the initial mass of sample. The carbon black content corresponds to the loss of mass measured during the oxidizable phase relative to the initial mass of sample.

### Measurement of the Acetone Extract:

The acetone extract content is measured according to the standard ISO1407 by means of an extractor of Soxhlet type.

A sample test specimen (between 500 mg and 5 g) is introduced into an extraction thimble and then placed in the extractor tube of the Soxhlet. A volume of acetone equal to two or three times the volume of the extractor tube is placed in the collector of the Soxhlet. The Soxhlet is subsequently assembled and then heated for 16 h.

The sample is weighed after extraction. The acetone extract content corresponds to the loss of mass of the sample during the extraction, relative to the initial mass thereof.

It is also possible to calculate the content of elastomer, which corresponds to the content of organic matter determined by thermogravimetric analysis from which the content of acetone extract is subtracted.

### Measurement of the Chloroform Extract:

The chloroform extract content is measured according to the standard ISO1407 by means of an extractor of Soxhlet type.

A sample test specimen (between 500 mg and 5 g) is introduced into an extraction thimble and then placed in the extractor tube of the Soxhlet. A volume of chloroform equal to two or three times the volume of the extractor tube is placed in the collector of the Soxhlet. The Soxhlet is subsequently assembled and then heated for 16 h.

The sample is weighed after extraction. The chloroform extract content corresponds to the loss of mass of the sample during the extraction, relative to the initial mass thereof.

### Measurement of the Average Molecular Masses of the Chloroform Extract:

The molecular masses are determined by size exclusion chromatography, according to a Moore calibration and according to the standard ISO16014.

The measurement of the weight-average molecular mass (Mw) of the chloroform extract is performed by size exclusion chromatography (SEC) with a refractive index (RI) detector. The system is composed of an Alliance 2695 system from Waters, of a column oven from Waters and also of an RI 410 detector from Waters. The set of columns used is composed of two PL GEL MIXED D columns (300×7.5 mm 5 μm) followed by two PL GEL MIXED E columns (300×7.5 mm 3 μm) from the company Agilent. These columns are placed in a column oven thermostatically controlled at 35° C. The mobile phase used is non-antioxidized tetrahydrofuran. The flow rate of the mobile phase is 1 ml/min. The RI detector is also thermostatically controlled at 35° C.

The chloroform extract is dried under a nitrogen stream. The dry extract is subsequently taken up at 1 g/l in non-antioxidized tetrahydrofuran at 250 ppm with stirring for 2 hours. The solution obtained is filtered using a syringe and a single-use 0.45 μm PTFE syringe filter. 100 μl of the filtered solution are injected into the conditioned chromatographic system at 1 ml/min and 35° C.

The Mw results are provided by integration of the chromatographic peaks detected by the RI detector above a value of 2000 g/mol. The Mw is calculated from a calibration performed using polystyrene standards.

### I-3 Reinforcing Filler

According to the invention, the rubber composition comprises a reinforcing filler, and preferably a carbon black as reinforcing filler. A reinforcing filler typically consists of nanoparticles whose mean (mass-average) size is less than a micrometre, generally less than 500 nm, usually between 20 and 200 nm, in particular and more preferentially between 20 and 150 nm.

Any carbon black, notably the blacks conventionally used in tyres or their treads (known as tyre-grade blacks), is suitable for use as carbon blacks. Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. When the rubber composition in accordance with the invention is used in a tread, the carbon black is preferentially a carbon black of the 100 or 200 series.

The content of carbon black may vary within a wide range and is adjusted by a person skilled in the art according to the envisaged use of the rubber composition, in particular in the tyre sector. For use of the rubber composition in a tread, in particular for vehicles intended to carry heavy loads, the content of carbon black in the rubber composition is preferentially between 25 phr and 65 phr. For such a use in the heavy goods vehicle sector, the rubber composition may have an insufficient level of reinforcement below 25 phr and may show excessive hysteresis above 65 phr.

### I-4 Crosslinking System

In the composition of the invention, use may be made of any type of crosslinking system known to those skilled in the art for rubber compositions.

The crosslinking system is preferably a vulcanization system, that is to say based on sulfur (or on a sulfur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), incorporated during the first non-productive phase and/or during the productive phase, as are described subsequently.

Sulfur is used in a preferred content of between 0.1 and 10 phr, more preferentially between 0.2 and 5 phr, in particular between 0.3 and 3 phr.

The vulcanization system of the composition according to the invention can also comprise one or more additional accelerators, for example compounds of the family of the thiurams, zinc dithiocarbamate derivatives, sulfenamides, guanidines or thiophosphates. Use may be made in particular of any compound that is capable of acting as accelerator of the vulcanization of diene elastomers in the presence of sulfur, notably accelerators of the thiazole type and derivatives thereof, and accelerators of thiuram or zinc dithiocarbamate type. These accelerators are more preferentially chosen from the group consisting of 2-mercaptobenzothiazole disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBBS”), N-(tert-butyl)-2-benzothiazolesulfenimide (abbreviated to “TBSI”), zinc dibenzyldithiocarbamate (abbreviated to “ZBEC”) and mixtures of these compounds. Preferably, use is made of an accelerator of the sulfenamide type.

According to a particular embodiment, a mixture of two vulcanization accelerators, known as primary and secondary accelerators, is used. Advantageously, the amount of vulcanization accelerator, i.e. the sum of the amount of primary accelerator and of the amount of secondary accelerator, is at least 0.5 phr.

Use may be made, as primary vulcanization accelerator, of any compound that is capable of acting as vulcanization accelerator for diene elastomers in the presence of sulfur, notably accelerators of thiazole type and also derivatives thereof, or accelerators of sulfenamide type. As examples of primary accelerators, mention may notably be made of sulfenamide compounds such as N-cyclohexyl-2-benzothiazylsulfenamide (“CBS”), N,N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide.

Any compound of the thiuram, dithiocarbamate, dithiophosphate, thiourea and xanthate type may be used as secondary vulcanization accelerator. As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

Preferably, the vulcanization accelerator is a mixture of a sulfenamide and of a thiuram disulfide. The vulcanization accelerator is advantageously a mixture of N-cyclohexyl-2-benzothiazylsulfenamide and of a thiuram disulfide, more advantageously a mixture of N-cyclohexyl-2-benzothiazylsulfenamide and of tetrabenzylthiuram disulfide.

Preferably, the mass ratio between the amount of secondary accelerator and the total amount of accelerators is less than 0.7, the total amount of accelerators. In other words, the mass content or mass amount of the secondary accelerator represents less than 70% by mass of the total amount of accelerators. Preferably, the mass ratio between the amount of secondary accelerator and the total amount of accelerators is greater than 0.05, more particularly between 0.05 and 0.7. Preferably, the mass ratio between the amount of secondary accelerator and the total amount of accelerators is preferentially less than 0.5 and even more preferentially less than or equal to 0.3. These preferential ranges make it possible to optimize the compromise between the cohesion properties and the press curing times by very greatly reducing the pressing time while at the same time maintaining good limit properties, even in the presence of a crack initiation site in the rubber composition.

According to a preferential embodiment, the mass ratio between the sulfur content and the total amount of accelerators in the rubber composition is less than 1, preferably less than or equal to 0.7, more preferentially less than 0.6. The use of such ratios makes it possible to obtain compositions with further improved cohesion properties.

### I-5 Other Possible Additives

The rubber composition that is useful for the purposes of the invention may also include all or some of the usual additives customarily used in elastomer compositions intended to be used in a tyre, for instance in a tyre tread. Such additives are, for example, fillers such as silicas, aluminas, processing agents, plasticizers (such as plasticizing oils or resins), anti-fatigue agents, reinforcing resins, methylene acceptors (for example phenolic novolac resin) or methylene donors (for example HMT or H3M), pigments, or protective agents such as anti-ozonant waxes, chemical anti-ozonants, and antioxidants.

Needless to say, the compositions according to the invention may be used alone or as a blend (i.e., as a mixture) with any other rubber composition which can be used for the manufacture of rubber articles, and according to one preferential embodiment, of tyres.

It goes without saying that the invention relates to the rubber compositions described previously both in the “uncured” or non-crosslinked state (i.e., before curing) and in the “cured” or crosslinked, or also vulcanized, state (i.e., after crosslinking or vulcanization).

### II—PROCESS FOR PREPARING THE RUBBER COMPOSITIONS

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first phase (non-productive) is performed as a single thermomechanical step during which all the necessary constituents, the optional additional processing agents and the other various additives, with the exception of the sulfur and the vulcanization accelerators, are introduced into a suitable mixer such as a conventional internal mixer. The total kneading time in this non-productive phase is preferably between 1 and 15 minutes. After cooling the mixture thus obtained during the first non-productive phase, the sulfur and the vulcanization accelerator are then incorporated at low temperature, generally into an external mixer such as an open mill; the whole is then mixed (productive phase) for a few minutes, for example between 2 and 15 minutes.

The final composition thus obtained can subsequently be calendered, for example in the form of a sheet or slab, in particular for laboratory characterization, or else extruded, in order to form, for example, a rubber profiled element used in the manufacture of semi-finished products for tyres. These products can subsequently be used for the manufacture of rubber articles such as tyres according to techniques known to those skilled in the art.

The crosslinking (or curing) can be performed in a known manner at a temperature generally of between 130° C. and 200° C., under pressure, for a sufficient time which may range, for example, between 5 and 90 min, as a function notably of the curing temperature, of the vulcanization system adopted, of the kinetics of crosslinking of the composition under consideration or else of the size of the article manufactured.

The examples that follow illustrate the invention without, however, limiting it.

### III—EXAMPLES OF IMPLEMENTATION OF THE INVENTION

### III-1 Characterization of the Rubber Compositions

In the examples, the rubber compositions are characterized after curing as indicated below.

### Fatigue:

The fatigue strength, expressed as number of cycles or in relative units (r.u.), is measured in a known manner on 12 test specimens subjected to repeated low-frequency tensile strains up to an elongation of 75%, at 23° C., using a Monsanto (MFTR) machine until the test specimen breaks, according to the standards ASTM D4482-85 and ISO40 6943.

The result is expressed in base 100 for facilitated comparison of the results. A value greater than that of the control, arbitrarily set at 100, indicates an improved result, that is to say a better fatigue strength of the rubber samples.

### Dynamic Properties:

The dynamic properties and more particularly the hysteresis as represented by the tan(δ)max, or also the stiffness as represented by the G*(50%) are measured on a viscoanalyser (Metravib VA4000), according to the standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under controlled temperature conditions (60° C.), is recorded. A strain amplitude sweep is performed from 0.1% to 100% (outward cycle) and then from 100% to 1% (return cycle). The results used here are, on the one hand, the loss factor tan(δ), representing the hysteresis of the compositions, and, on the other hand, the stiffness at 50% strain G*(50%). For the outward cycle, the maximum value of tan(δ) observed, denoted tan(δ)max, is indicated.

The results are expressed in terms of performance in base 100, that is to say that the value 100 is arbitrarily assigned to the best control, in order to calculate and subsequently compare the tan(δ)max and the G*(50%) of the various solutions tested. For the tan(δ)max, a lower value represents a decrease in hysteresis performance (i.e. a larger tan(δ)max value) while a higher value represents a better performance. For the G*(50%), a lower value represents a decrease in stiffness performance (i.e. a lower value of G*(50%)) while a higher value represents a better performance.

### III-2 Rubber Compositions

The elastomer (EBR) is prepared according to the following procedure: 30 mg of metallocene [{Me2SiFlu2Nd(μ-BH4)2Li(THF)}2, the symbol Flu representing the fluorenyl group of formula C13H8], are introduced into a first Steinie bottle in a glovebox. The co-catalyst, butyloctylmagnesium dissolved beforehand in 300 ml of methylcyclohexane in a second Steinie bottle, is introduced into the first Steinie bottle containing the metallocene in the following proportions: 0.00007 mol/L of metallocene, 0.0004 mol/L of co-catalyst. After contact for 10 minutes at ambient temperature, a catalytic solution is obtained. The catalytic solution is then introduced into the polymerization reactor. The temperature in the reactor is then increased to 80° C. When this temperature is reached, the reaction starts by injection of a gaseous mixture of ethylene and 1,3-butadiene (80/20 mol %) into the reactor. The polymerization reaction proceeds at a pressure of 8 bar. The proportions of metallocene and of co-catalyst are, respectively, 0.00007 mol/L and 0.0004 mol/L. The polymerization reaction is stopped by cooling, degassing of the reactor and addition of ethanol. An antioxidant is added to the polymer solution. The copolymer is recovered by drying in a vacuum oven.

The rubber compositions, the details of the formulation of which are given in Table 1, were prepared in the following manner:

The elastomer, the reinforcing filler and the various other ingredients, with the exception of the sulfur and the vulcanization accelerator, are successively introduced into an internal mixer (final degree of filling: about 70% by volume), the initial vessel temperature of which is about 80° C. Thermomechanical working (non-productive phase) is then performed in one step, which lasts in total approximately 3 to 4 min, until a maximum “dropping” temperature of 165° C. is reached. The mixture thus obtained is recovered and cooled, and sulfur and the vulcanization accelerator are then incorporated on a mixer (homofinisher) at 30° C., the whole being mixed (productive phase) for an appropriate time (for example approximately ten minutes).

The compositions thus obtained are subsequently calendered, either in the form of slabs (thickness of 2 to 3 mm) or of thin sheets of rubber, for measurement of their physical or mechanical properties, or extruded in the form of a tyre tread.

Of the compositions shown in Table 1, only composition C2 is in accordance with the invention. Compositions T1 to T3, C1 and C3 are comparative tests to illustrate the effect of the invention. The performance of the compositions is presented in Table 2.

TABLE 1

| Composition | T1 | T2 | T3 | C1 | C2 | C3 |
|---|---|---|---|---|---|---|
| NR (1) | 60 | 60 | 60 | — | — | — |
| SBR (2) | 20 | 20 | 20 | — | — | — |
| BR (3) | 20 | 20 | 20 | — | — | — |
| EBR (4) | — | — | — | 100 | 100 | 100 |
| Crumb (5) | — | 8.5 | 18 | — | 8.5 | 17 |
| Crumb (m %) | — | 5% | 10% | — | 5% | 10% |
| Carbon black (6) | 54 | 54 | 54 | 40 | 40 | 40 |
| Antioxidant (7) | 2 | 2 | 2 | 2 | | |
| Stearic acid (8) | 1.5 | 1.5 | 1.5 | 1.5 | 1.5 | 1.5 |
| Zinc oxide (9) | 2.5 | 2.5 | 2.5 | 2.5 | 2.5 | 2.5 |
| Accelerator 1 (10) | 1.1 | 1.1 | 1.1 | 0.5 | 0.5 | 0.5 |
| Accelerator 2 (11) | — | — | — | 0.5 | 0.5 | 0.5 |
| Accelerator 3 (12) | — | — | — | 0.3 | 0.3 | 0.3 |
| Sulfur | 1.1 | 1.1 | 1.1 | 0.4 | 0.4 | 0.4 |

(1) NR: Natural rubber
(2) SBR with 15.5% by weight of styrene units and, for the butadiene part, 24% of 1,2 units and Tg = −65° C.
(3) BR: polybutadiene, CB24 from Lanxess; 96% of cis-1,4; Tg = −107° C.
(4) EBR: Elastomer containing 79 mol % of ethylene units, 7 mol % of 1,2-cyclohexanediyl units, 8 mol % of 1,2-butadienyl units, and 6 mol % of 1,4-butadienyl units, prepared as indicated above
(5) Polydine PD 80 crumb from the company Lehigh Technologies
(6) Carbon black, ASTM N234 grade
(7) N-(1,3-Dimethylbutyl)-N′-phenyl-p-phenylenediamine (Santoflex 6-PPD) from the company Flexsys
(8) “Pristerene 4931” stearin from the company Uniqema
(9) Zinc oxide, industrial grade - from Umicore
(10) N-Cyclohexyl-2-benzothiazolesulfenamide (Santocure CBS from the company Flexsys)
(11) Diphenylguanidine (Perkacit DPG from the company Flexsys)
(12) Tetrabenzylthiuram disulfide (Perkacit TBZTD from the company Flexsys)

TABLE 2

| Performance | T1 | T2 | T3 | C1 | C2 | C3 |
|---|---|---|---|---|---|---|
| Fatigue (base 100) | 100 | 79 | 68 | 100 | 195 | 11 |
| G*50% | 100 | 105 | 106 | 100 | 104 | 110 |
| Tan(δ)max | 100 | 103 | 101 | 100 | 100 | 99 |

It is noted that composition C2, alone in accordance with the invention, surprisingly shows a very great improvement in its endurance, as measured by its fatigue strength, while retaining optimum stiffness and hysteresis.

1.-13. (canceled)

14. A rubber composition based on at least:
50 to 100 phr of a copolymer containing ethylene units and 1,3-diene units, the ethylene units in the copolymer representing more than 50 mol % of the monomer units of the copolymer;
0.1% to 9% by mass of crumb rubber;
a reinforcing filler; and
a crosslinking system.

15. The rubber composition according to claim 14, wherein the copolymer containing ethylene units and 1,3-diene units comprises at least 65 mol % of ethylene units.

16. The rubber composition according to claim 14, wherein the 1,3-diene is 1,3-butadiene.

17. The rubber composition according to claim 14, wherein the content of the copolymer containing ethylene units and 1,3-diene units in the rubber composition is within a range from 80 to 100 phr.

18. The rubber composition according to claim 14, wherein the crumb rubber has an acetone extract of between 3% and 30% by mass.

19. The rubber composition according to claim 14, wherein the crumb rubber has a chloroform extract of between 3% and 85% by mass.

20. The rubber composition according to claim 14, wherein the crumb rubber has a ratio of chloroform extract to acetone extract, expressed as a mass percentage, of less than 1.5.

21. The rubber composition according to claim 14, wherein the crumb rubber has a mean size D50 of between 100 and 300 μm.

22. The rubber composition according to claim 14, wherein the crumb rubber has a particle size distribution such that a mean size ratio D10/D50 is greater than or equal to 0.5.

23. The rubber composition according to claim 14, wherein the content of crumb rubber is within a range from 0.5% to 7% by mass.

24. The rubber composition according to claim 14, wherein the reinforcing filler comprises carbon black.

25. A rubber article comprising the rubber composition according to claim 14.

26. A tire comprising the rubber composition according to claim 14.
